(19) United States
(12) Patent Application Publication
(10) Pub. No.: US 2026/0362292 A1
(43) Pub. Date: Nov. 12, 2026

(54) COMMUNICATIONS BETWEEN RADIO ACCESS NETWORK (RAN) NODES VIA INTER-RAN NODES

(71) Applicant: QUALCOMM Incorporated, San Diego, CA (US)

(72) Inventors: Karthika PALADUGU, Hyderabad (IN); Gavin Bernard HORN, La Jolla, CA (US); Karl Georg HAMPEL, Jersey City, NJ (US)

(21) Appl. No.: 19/203,892

(22) Filed: May 9, 2025

(51) Int. Cl. H04W 40/24; H04W 24/10

(52) U.S. Cl. CPC H04W 40/246; H04W 24/10

(57) ABSTRACT

Various aspects of the present disclosure generally relate to wireless communication. In some aspects, a second radio access technology (RAT) may discover an inter-RAN node associated with a first RAT RAN node. The RAT may register the second RAT RAN node with the inter-RAN node. The RAT may communicate with the first RAT RAN node via the inter-RAN node. Numerous other aspects are described.

### FIELD OF THE DISCLOSURE

Aspects of the present disclosure generally relate to wireless communication and specifically relate to techniques, apparatuses, and methods associated with communications between radio access network (RAN) nodes via inter-RAN nodes.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

### SUMMARY

The systems, methods, and devices of this disclosure each have several innovative aspects, no single one of which is solely responsible for the desirable attributes disclosed herein.

In some implementations, an apparatus for wireless communication at an inter-radio-access-network (RAN) node includes one or more memories; and one or more processors coupled to the one or more memories, the one or more processors individually or collectively configured to: receive a first message from a first radio access technology (RAT) RAN node via a first interface; convert the first message to a second message that is associated with a second interface; and transmit the second message to a second RAT RAN node via the second interface.

In some implementations, an apparatus for wireless communication at a second RAT RAN node includes one or more memories; and one or more processors coupled to the one or more memories, the one or more processors individually or collectively configured to: discover an inter-RAN node associated with a first RAT RAN node; register the second RAT RAN node with the inter-RAN node; and communicate with the first RAT RAN node via the inter-RAN node.

In some implementations, a method of wireless communication performed by an inter-RAN node includes receiving a first message from a first RAT RAN node via a first interface; converting the first message to a second message that is associated with a second interface; and transmitting the second message to a second RAT RAN node via the second interface.

In some implementations, a method of wireless communication performed by a second RAT RAN node includes discovering an inter-RAN node associated with a first RAT RAN node; registering the second RAT RAN node with the inter-RAN node; and communicating with the first RAT RAN node via the inter-RAN node.

In some implementations, a non-transitory computer-readable medium storing a set of instructions for wireless communication includes one or more instructions that, when executed by one or more processors of an inter-RAN node, cause the inter-RAN node to: receive a first message from a first RAT RAN node via a first interface; convert the first message to a second message that is associated with a second interface; and transmit the second message to a second RAT RAN node via the second interface.

In some implementations, a non-transitory computer-readable medium storing a set of instructions for wireless communication includes one or more instructions that, when executed by one or more processors of a second RAT RAN node, cause the second RAT RAN node to: discover an inter-RAN node associated with a first RAT RAN node; register the second RAT RAN node with the inter-RAN node; and communicate with the first RAT RAN node via the inter-RAN node.

In some implementations, an apparatus for wireless communication includes means for receiving a first message from a first RAT RAN node via a first interface; means for converting the first message to a second message that is associated with a second interface; and means for transmitting the second message to a second RAT RAN node via the second interface.

In some implementations, an apparatus for wireless communication includes means for discovering an inter-RAN node associated with a first RAT RAN node; means for registering the second RAT RAN node with the inter-RAN node; and means for communicating with the first RAT RAN node via the inter-RAN node.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless network.

FIG. 2 is a diagram illustrating an example of a radio access network (RAN) reference point architecture.

FIG. 3 is a diagram illustrating an example of a RAN service based architecture.

FIG. 4 is a diagram illustrating an example associated with an architecture of an inter-RAN node.

FIG. 5 is a diagram illustrating an example associated with multiple inter-RAN nodes in a wireless network.

FIG. 6 is a diagram illustrating an example associated with a control plane protocol stack.

FIG. 7 is a diagram illustrating an example associated with a node service registration.

FIG. 8 is a diagram illustrating an example associated with a protocol conversion.

FIG. 9 is a diagram illustrating an example associated with user equipment (UE)-associated message routing.

FIG. 10 is a diagram illustrating an example associated with communication via an inter-RAN node.

FIG. 11 is a diagram illustrating an example associated with a node registration.

FIG. 12 is a flowchart illustrating an example process performed, for example, by an inter-RAN node.

FIG. 13 is a flowchart illustrating an example process performed, for example, by a second radio access technology (RAT) RAN node.

FIGS. 14-15 are diagrams of example apparatuses for wireless communication.

### DETAILED DESCRIPTION

In a radio access network (RAN) reference point architecture, such as a Fifth Generation (5G) RAN reference point architecture, a network node may include a control unit control plane (CU-CP), a control unit user plane (CU-UP) (or multiple CU-UPs), and a distributed unit (DU) (or multiple DUs). The CU-CP may be associated with an access and mobility management function (AMF). The CU-UP may be associated with a user plane function (UPF). The DU may be associated with a radio unit (RU). An F1-C interface may connect the CU-CP and the DU. An F1-U interface may connect the CU-UP and the DU. An E1 interface may connect the CU-CP and the CU-UP. An Xn interface may connect the CU-CP to a peer CU-CP. An N2 interface may connect the CU-CP to the AMF. An N3 interface may connect the CU-UP and the UPF. An open fronthaul interface (OFI) may connect the DU and the RU. The OFI may be a DU-to-RU interface, which may be a point-to-point interface (PPI). The DU may be connected to the CU-CP (e.g., one DU may be connected to only one CU-CP). The DU may be connected to a plurality of CU-UPs. The CU-UP may be connected to the CU-CP (e.g., one CU-UP may be connected to only one CU-CP).

In a RAN service based architecture, such as a Sixth Generation (6G) RAN service based architecture, a RAN may include a CU-CP (or multiple CU-CPs), a CU-UP (or multiple CU-UPs), and a DU (or multiple DUs). A RAN reference point architecture may be migrated to the RAN service based architecture. The CU-UP may be connected to a UPF. The DU may be connected to an RU. An N3 interface may connect the CU-UP and the UPF. An F1-U interface may connect the CU-UP and the DU. An OFI may connect the DU and the RU. The RAN may be connected to a core, such as a 6G core. CU-CP services may be accessed via Ncu-cp application programming interfaces (APIs). CU-UP services may be accessed via Ncu-up APIs. DU services may be accessed via Ndu APIs. Service-based interfaces may be for control (e.g., service-based interfaces may be for control only). The DU may support signaling with a plurality of CU-CPs. The DU may support signaling with a plurality of CU-UPs. The CU-UP may support signaling with a plurality of CU-CPs.

A legacy RAN node, such as a Fourth Generation (4G) RAN or a 5G RAN, may support a PPI (e.g., the legacy RAN node may only support the PPI). Xn application protocol (XnAP) messages may be transported over stream control transport protocol (SCTP). A non-legacy RAN node, such as a 6G RAN node, may support a service-based interface (SBI). The non-legacy RAN node may utilize hypertext transfer protocol (HTTP)/2 with JavaScript object notation (JSON) for application layer encoding. The non-legacy RAN node may utilize transmission control protocol (TCP) as a transport layer with support for transport layer security (TLS) for security. Coordination between the legacy RAN node and the non-legacy RAN node may be useful for features, such as inter-radio access technology (RAT) dual connectivity and inter-RAT handover support. The inter-RAT dual connectivity may improve throughput and reliability. The inter-RAT handover support may reduce handover latencies. However, such coordination may not be supported between the legacy RAN node and the non-legacy RAN node, thereby preventing the inter-RAT dual connectivity and the inter-RAT handover support. In other words, communication between the legacy RAN node and the non-legacy RAN node, which may support PPI and SBI, respectively, may not be supported, which may prevent such features from being supported, thereby degrading an overall system performance.

Various aspects relate generally to an inter-RAN node. Some aspects more specifically relate to an inter-RAN node for relaying messages between RAN nodes associated with different RATs and different interfaces. In some examples, an inter-RAN node may receive a first message from a first RAT RAN node via a first interface. The inter-RAN node may convert the first message to a second message that is associated with a second interface. The inter-RAN node may transmit the second message to a second RAT RAN node via the second interface. In some aspects, the inter-RAN node may receive a third message from the second RAT RAN node via the second interface. The inter-RAN node may convert the third message to a fourth message that is suitable for the first interface. The inter-RAN node may transmit the fourth message to the first RAT RAN node via the first interface.

In some aspects, the inter-RAN node may be a node, an adapter, an adaptor, or another entity that is capable of converting messages across legacy and non-legacy systems. The inter-RAN node may be capable of managing states of the messages before forwarding the messages across interfaces. In some aspects, the inter-RAN node may be implemented as a network node or as a service. For example, the inter-RAN node may be implemented as a separate service, or the inter-RAN node may be a service function absorbed in other services in the network.

In some aspects, the first RAT RAN node may be a legacy RAN node. The second RAT RAN node may be a non-legacy RAN node. The first interface may be a PPI. The second interface may be an SBI. The first message may be an XnAP message. The second message may be an HTTP message. In some aspects, the first RAT RAN node may be a non-legacy RAN node. The second RAT RAN node may be a legacy RAN node. The first interface may be an SBI. The second interface may be a PPI. The first message may be an HTTP message. The second message may be an XnAP message.

In some aspects, the second RAT RAN node may discover the inter-RAN node associated with the first RAT RAN node. The second RAT RAN node may register the second RAT RAN node with the inter-RAN node (e.g., the second RAT RAN node may register itself with the inter-RAN node). The second RAT RAN node may communicate with the first RAT RAN node via the inter-RAN node. In some aspects, the first RAT RAN node may be the legacy RAN node associated with the first interface, and the second RAT RAN node may be the non-legacy RAN node associated with the second interface.

Particular aspects of the subject matter described in this disclosure can be implemented to realize one or more of the following potential advantages. In some examples, by implementing the inter-RAN node, the described techniques can be used to convey messages between the first RAT RAN node associated with the first interface and the second RAT RAN node associated with the second interface. The inter-RAN node may be a new node to support an inter-operation between RAN nodes associated with different RATs and different interfaces. For example, the inter-RAN node may support an inter-operation between RAN nodes associated with PPI and SBI, respectively. As a result, the inter-RAN node may support coordination between the first interface and the second RAT RAN node, which may be useful for inter-RAT dual connectivity or inter-RAT handover support. Such coordination may improve throughput, improve reliability, or reduce handover latency. As a result, an ability to coordinate messages between the RAN nodes associated with the different RATs and the different interfaces via the inter-RAN node may improve an overall system performance.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

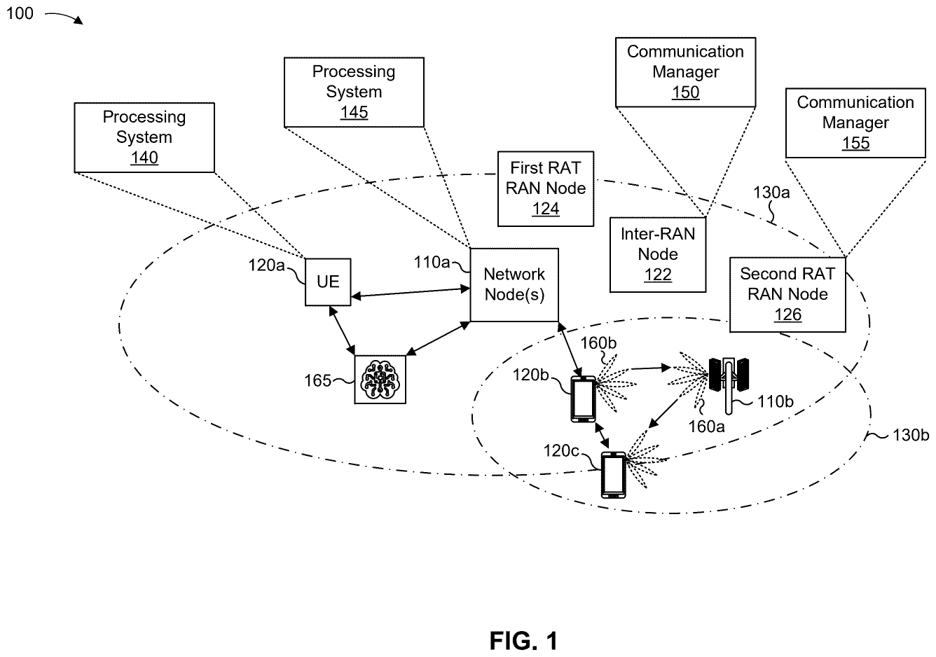

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more APIs or management interfaces for use cases, such as beam management, radio resource monitoring (RRM) relaxation, mobility prediction, load prediction, network energy savings, or coverage and capacity improvements, among other examples).

In some aspects, an inter-RAN node (e.g., inter-RAN node 122) may include a communication manager 150. As described in more detail elsewhere herein, the communication manager 150 may receive a first message from a first RAT RAN node (e.g., first RAT RAN node 124) via a first interface; convert the first message to a second message that is associated with a second interface; and transmit the second message to a second RAT RAN node (e.g., second RAT RAN node 126) via the second interface. Additionally, or alternatively, the communication manager 150 may perform one or more other operations described herein.

In some aspects, a second RAT RAN node (e.g., second RAT RAN node 126) may include a communication manager 155. As described in more detail elsewhere herein, the communication manager 155 may discover an inter-RAN node (e.g., inter-RAN node 122) associated with a first RAT RAN node (e.g., first RAT RAN node 124); register the second RAT RAN node with the inter-RAN node; and communicate with the first RAT RAN node via the inter-RAN node. Additionally, or alternatively, the communication manager 155 may perform one or more other operations described herein.

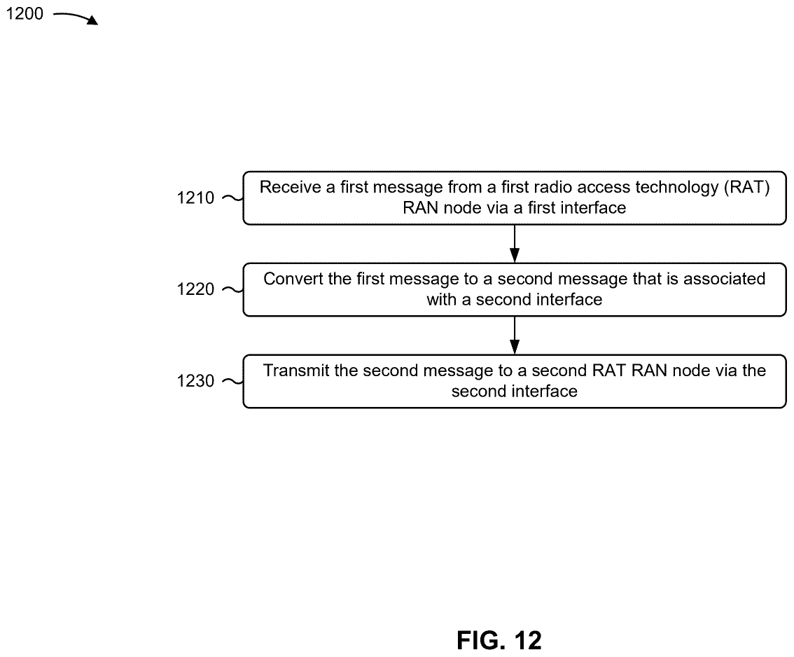

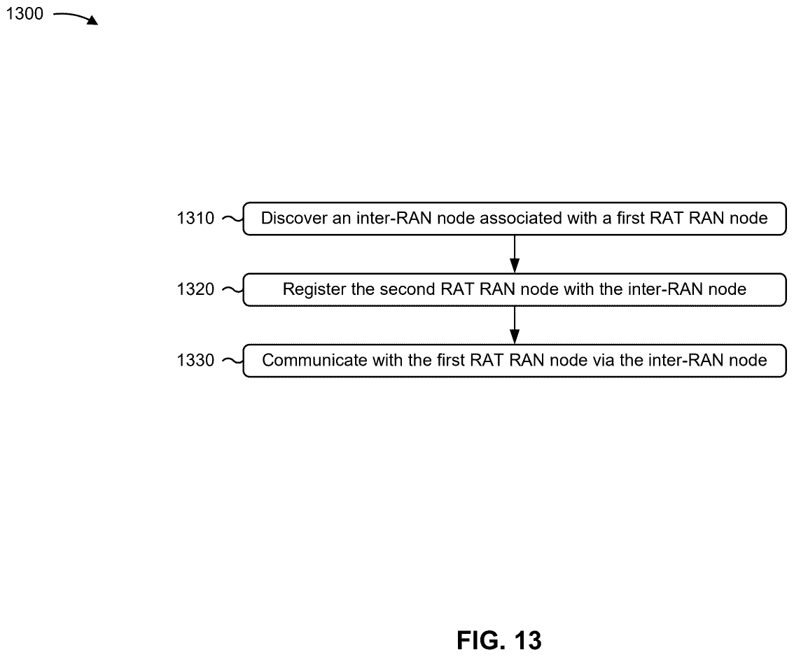

The network node 110, the processing system 145 of the network node 110, the UE 120, the processing system 140 of the UE 120, or any other component(s) of FIG. 1 may implement one or more techniques or perform one or more operations associated with communications between RAN nodes via inter-RAN nodes, as described in more detail elsewhere herein. For example, the processing system 145 of the network node 110, or the processing system 140 of the UE 120 may perform or direct operations of, for example, process 1200 of FIG. 12, process 1300 of FIG. 13, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 1200 of FIG. 12, process 1300 of FIG. 13, or other processes as described herein. In some examples, executing instructions may include running the instructions, converting the instructions, compiling the instructions, or interpreting the instructions, among other examples.

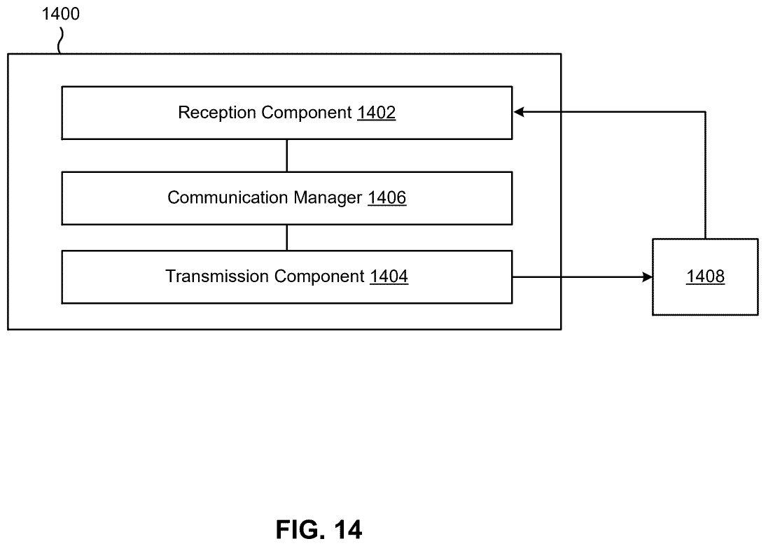

In some aspects, an inter-RAN node includes means for receiving a first message from a first RAT RAN node via a first interface; means for converting the first message to a second message that is associated with a second interface; or means for transmitting the second message to a second RAT RAN node via the second interface. In some aspects, the means for the inter-RAN node to perform operations described herein may include, for example, one or more of communication manager 150, processing system 145, a radio, one or more RF chains, one or more transceivers, one or more antennas, one or more modems, a reception component (for example, reception component 1402 depicted and described in connection with FIG. 14), or a transmission component (for example, transmission component 1404 depicted and described in connection with FIG. 14), among other examples.

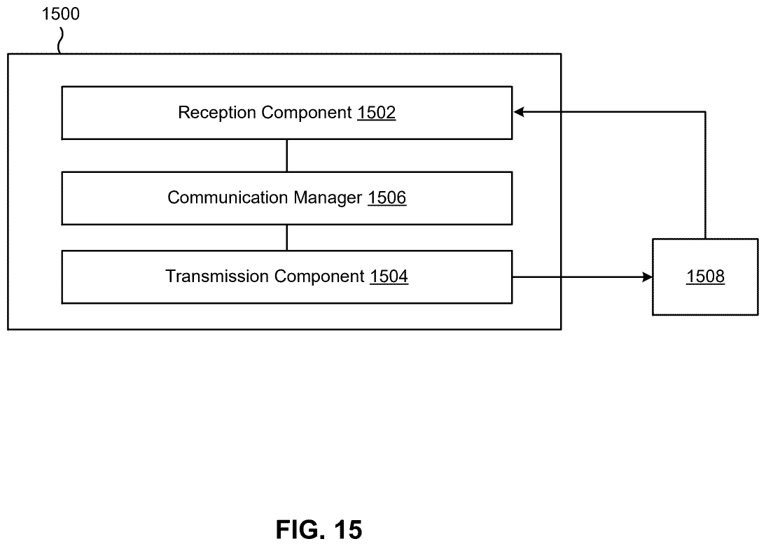

In some aspects, a second RAT RAN node includes means for discovering an inter-RAN node associated with a first RAT RAN node; means for registering the second RAT RAN node with the inter-RAN node; or means for communicating with the first RAT RAN node via the inter-RAN node. In some aspects, the means for the second RAT to perform operations described herein may include, for example, one or more of communication manager 155, processing system 145, a radio, one or more RF chains, one or more transceivers, one or more antennas, one or more modems, a reception component (for example, reception component 1502 depicted and described in connection with FIG. 15), or a transmission component (for example, transmission component 1504 depicted and described in connection with FIG. 15), among other examples.

As indicated above, FIG. 1 is provided as an example. Other examples may differ from what is described with regard to FIG. 1.

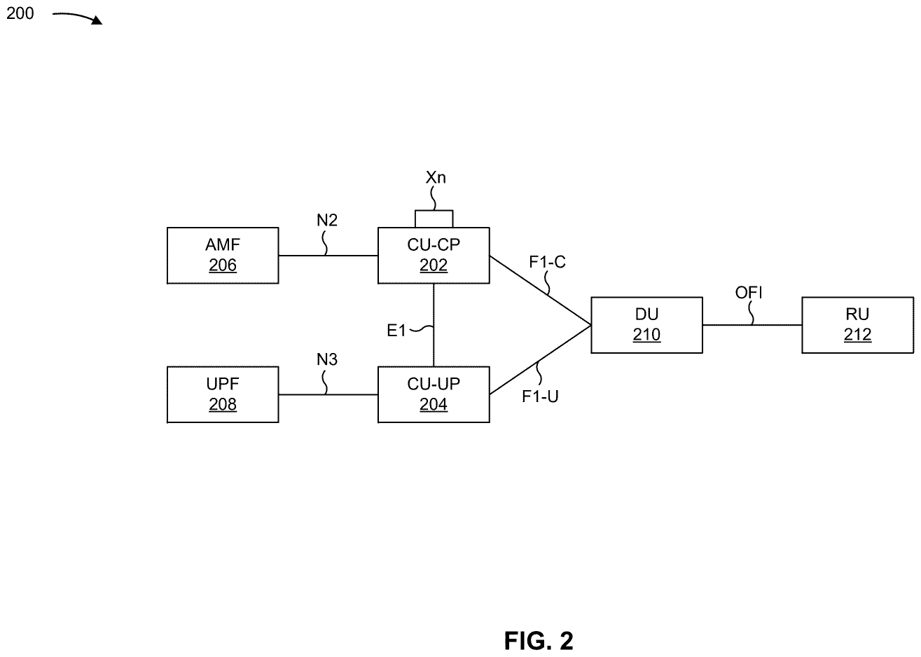

FIG. 2 is a diagram illustrating an example 200 of a RAN reference point architecture.

As shown in a RAN reference point architecture, such as a 5G RAN reference point architecture, a network node may include a CU-CP 202, a CU-UP 204 (or multiple CU-UPs), and a DU 210 (or multiple DUs). The CU-CP 202 may be associated with an access and mobility management function (AMF) 206. The CU-UP 204 may be associated with a UPF 208. The DU 210 may be associated with an RU 212. An F1-C interface may connect the CU-CP 202 and the DU 210. An F1-U interface may connect the CU-UP 204 and the DU 210. An E1 interface may connect the CU-CP 202 and the CU-UP 204. An Xn interface may connect the CU-CP 202 to a peer CU-CP. An N2 interface may connect the CU-CP 202 to the AMF 206. An N3 interface may connect the CU-UP 204 and the UPF 208. An OFI may connect the DU 210 and the RU 212. The OFI may be a DU-to-RU interface, which may be a PPI. The DU 210 may be connected to the CU-CP 202 (e.g., one DU may be connected to only one CU-CP). The DU 210 may be connected to a plurality of CU-Ups. The CU-UP 204 may be connected to the CU-CP 202 (e.g., one CU-UP may be connected to only one CU-CP).

As indicated above, FIG. 2 is provided as an example. Other examples may differ from what is described with regard to FIG. 2.

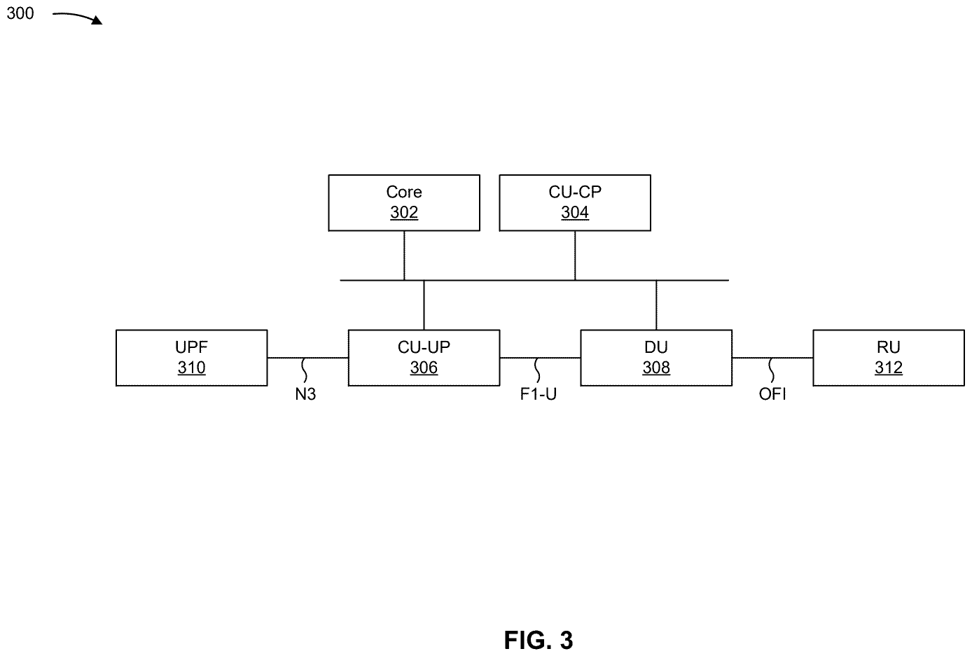

FIG. 3 is a diagram illustrating an example 300 of a RAN service based architecture.

As shown in FIG. 3, in a RAN service based architecture, such as a 6G RAN service based architecture, a RAN may include a CU-CP 304 (or multiple CU-CPs), a CU-UP 306 (or multiple CU-UPs), and a DU 308 (or multiple DUs). A RAN reference point architecture may be migrated to the RAN service based architecture. The CU-UP 306 may be connected to a UPF 310. The DU 308 may be connected to an RU 312. An N3 interface may connect the CU-UP 306 and the UPF 310. An F1-U interface may connect the CU-UP 306 and the DU 308. An OFI may connect the DU 308 and the RU 312. The RAN may be connected to a core 302, such as a 6G core. CU-CP services may be accessed via Ncu-cp APIs. CU-UP services may be accessed via Ncu-up APIs. DU services may be accessed via Ndu APIs. Service-based interfaces may be for control (e.g., service-based interfaces may be for control only). The DU 308 may support signaling with a plurality of CU-CPs. The DU 308 may support signaling with a plurality of CU-UPs. The CU-UP 306 may support signaling with a plurality of CU-CPs.

As indicated above, FIG. 3 is provided as an example. Other examples may differ from what is described with regard to FIG. 3.

A legacy RAN node, such as a 4G RAN or a 5G RAN, may support a PPI (e.g., the legacy RAN node may only support the PPI). XnAP messages may be transported over SCTP. A non-legacy RAN node, such as a 6G RAN node, may support an SBI. The non-legacy RAN node may utilize HTTP/2 with JSON for application layer encoding. The non-legacy RAN node may utilize TCP as a transport layer with support for TLS for security. The non-legacy RAN node may use other protocols. For example, for application layer encodings, non-legacy RAN node may use JSON, protocol buffers (e.g., an open-source cross-platform data format used to serialize structured data), or abstract syntax notation (ASN.1). The transport layer, which may be used to carry HTTP/2, may utilize TCP and TLS, stream control transmission protocol (SCTP) and TLS, or quick user datagram protocol (UDP) Internet connections (QUIC). Coordination between the legacy RAN node and the non-legacy RAN node may be useful for features, such as inter-RAT dual connectivity and inter-RAT handover support. The inter-RAT dual connectivity may improve throughput and reliability. The inter-RAT handover support may reduce handover latencies. However, such coordination may not be supported between the legacy RAN node and the non-legacy RAN node, thereby preventing the inter-RAT dual connectivity and the inter-RAT handover support. In other words, communication between the legacy RAN node and the non-legacy RAN node, which may support PPI and SBI, respectively, may not be supported, which may prevent such features from being supported, thereby degrading an overall system performance.

In various aspects of techniques and apparatuses described herein, an inter-RAN node may receive a first message from a first RAT RAN node via a first interface. The inter-RAN node may convert the first message to a second message that is associated with a second interface. The inter-RAN node may transmit the second message to a second RAT RAN node via the second interface. In some aspects, the inter-RAN node may receive a third message from the second RAT RAN node via the second interface. The inter-RAN node may convert the third message to a fourth message that is suitable for the first interface. The inter-RAN node may transmit the fourth message to the first RAT RAN node via the first interface.

In some aspects, the first RAT RAN node may be a legacy RAN node. The second RAT RAN node may be a non-legacy RAN node. The first interface may be a PPI. The second interface may be an SBI. The first message may be an XnAP message. The second message may be an HTTP message. In some aspects, the first RAT RAN node may be a non-legacy RAN node. The second RAT RAN node may be a legacy RAN node. The first interface may be an SBI. The second interface may be a PPI. The first message may be an HTTP message. The second message may be an XnAP message.

In some aspects, the first message may indicate a source RAN node ID associated with the first RAT RAN node and a target RAN node ID associated with the second RAT RAN node. In some aspects, the first message and the second message may be control plane messages. In some aspects, when converting the first message to the second message, the inter-RAN node may decode the first message, determine the second interface based at least in part on information indicated in the first message, and encode the second message in accordance with the second interface.

In some aspects, the inter-RAN node may transmit, to a network repository function (NRF), a registration message for registering as an inter-RAN node service support with the NRF. The registration message may indicate one or more discovered RAN node IDs. The inter-RAN node service support may be for a communication between RAN nodes associated with different RATs and different interface types. In some aspects, a wireless network may include a first inter-RAN node and a second inter-RAN node, where the first inter-RAN node may not have an interface to the second inter-RAN node.

In some aspects, the inter-RAN node may discover a RAN node transport network layer (TNL) ID associated with the second RAT RAN node. The inter-RAN node may maintain a mapping table that includes the RAN node TNL ID and a corresponding RAN node ID. The inter-RAN node may route traffic between the first RAT RAN node and the second RAT RAN node based at least in part on the mapping table and routing information provided by one or more of the first RAT RAN node or the second RAT RAN node.

In some aspects, the inter-RAN node, such as a 6G inter-RAN horizontal node, may be a new node to support inter-operation between RAN nodes that support PPI and SBI. The inter-RAN node may support inter-operation between the first RAT RAN node and the second RAT RAN node. The first RAT RAN node may be a legacy RAN node associated with PPI, and the second RAT RAN node may be a non-legacy RAN node associated with SBI. For example, the first RAT RAN node may be a 4G/5G RAN node and the second RAT RAN node may be a 6G RAN node. In this example, a first RAT may be associated with 4G/5G and a second RAT may be associated with 6G. The inter-RAN node may be able to communicate with both the first RAT RAN node and the second RAT RAN node. The inter-RAN node may support various architectures, functions, and basic procedures.

In some aspects, the second RAT RAN node may discover the inter-RAN node associated with the first RAT RAN node. The second RAT RAN node may register the second RAT RAN node with the inter-RAN node (e.g., the second RAT RAN node may register itself with the inter-RAN node). The second RAT RAN node may communicate with the first RAT RAN node via the inter-RAN node. In some aspects, the first RAT RAN node may be the legacy RAN node associated with the first interface, and the second RAT RAN node may be the non-legacy RAN node associated with the second interface.

In some aspects, the second RAT RAN node may transmit, to a UE, a measurement configuration to monitor and report measurements associated with one or more first RAT neighbor cells. The second RAT RAN node may receive, from the UE, a measurement report based at least in part on the measurement configuration. The measurement report may include information associated with the first RAT RAN node. The inter-RAN node may be discovered based at least in part on the first RAT RAN node.

In some aspects, the second RAT RAN node, when discovering the inter-RAN node, may transmit signaling to the NRF to identify a node ID associated with the inter-RAN node. In some aspects, the second RAT RAN node may maintain a neighbor cell relation table (NCRT) that indicates a first RAT cell that is associated with the first RAT RAN node. The NCRT may be based at least in part on one or more measurement reports for one or more first RAT neighbor cells. In some aspects, the second RAT RAN node, when registering the second RAT RAN node with the inter-RAN node, may transmit, to the inter-RAN node, a registration request that indicates a global RAN node ID. The second RAT RAN node may receive, from the inter-RAN node and based at least in part on the registration request, a registration response that indicates a global inter-RAN node ID.

In some aspects, the inter-RAN node may be discovered based at least in part on a configuration received from an operations and management (OAM) entity. The configuration may indicate one or more node IDs associated with a range of first RAT RAN node IDs. In some aspects, the inter-RAN node may be discovered based at least in part on one or more UE-reported node IDs corresponding to one or more first RAT cells. In some aspects, the inter-RAN node may be discovered based at least in part on a first RAT TNL ID discovery via an AMF. In some aspects, the inter-RAN node may be discovered based at least in part on an NRF service discovery. In some aspects, the inter-RAN node may be discovered based at least in part on an inter-RAN node registration. In some aspects, the second RAT RAN node may obtain information associated with the inter-RAN node as part of an inter-RAN node registration with the second RAT RAN node.

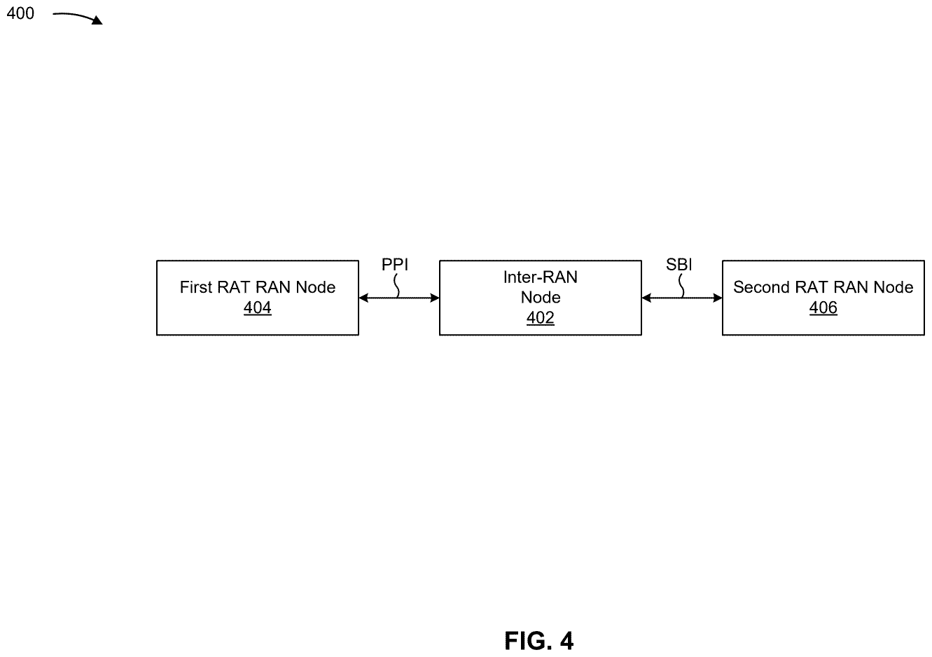

FIG. 4 is a diagram illustrating an example 400 associated with an architecture of an inter-RAN node.

As shown in FIG. 4, an inter-RAN node 402, such as an inter-RAN horizontal node, may be connected to a first RAT RAN node 404 and a second RAT RAN node 406. The first RAT RAN node 404 may be a legacy RAN node, such as a 4G/5G RAN node. The second RAT RAN node 406 may be a non-legacy RAN node, such as a 6G RAN node. The first RAT RAN node 404 may support PPI, and the second RAT RAN node 406 may support SBI. The inter-RAN node 402 may be a node that supports an exchange of control messages between the first RAT RAN node 404 and the second RAT RAN node 406. The inter-RAN node 402 may support the exchange of control messages between RAN nodes support PPI/XnAP and SBI.

In some aspects, the inter-RAN node 402 may perform various functionalities. The inter-RAN node 402 may perform a RAN node discovery. The inter-RAN node 402 may discover RAN nodes via an NRF, domain name system (DNS), PPI, or SBI interface management procedures. The inter-RAN node 402 may perform a node service registration. The inter-RAN node 402 may perform a PPI-SBI protocol conversion. The inter-RAN node 402 may perform inter-RAN control plane traffic routing. The inter-RAN control plane traffic routing may be for both non-UE associated messages and UE-associated messages. The inter-RAN control plane traffic routing may include a UE associated logical PPI/SBI context handling.

In some aspects, the inter-RAN node 402 may perform the inter-RAN control plane traffic routing. The inter-RAN node 402 may discover a RAN node TNL identifier (ID) during a RAN node discovery procedure. The inter-RAN node 402 may maintain a mapping table of RAN node IDs and TNL IDs. The inter-RAN node 402 may route traffic between RAN nodes based at least in part on the mapping table and routing information provided by RAN nodes. The inter-RAN node 402 may route both non-UE associated messages and UE associated messages. The inter-RAN node 402 may store information received from the RAN nodes. The inter-RAN node 402 may use the stored information in corresponding control plane procedures on an Xn interface and an SBI. The inter-RAN node 402 may trigger a corresponding Xn/SBI procedure to an appropriate RAN node for every message received on either interface based at least in part on a routing table.

In some aspects, the first RAT RAN node 404 may identify that a connection to the second RAT RAN node 406 is via the inter-RAN node 402, or alternatively, the second RAT RAN node 406 may identify that a connection to the first RAT RAN node 404 is via the inter-RAN node 402.

In some aspects, the first RAT RAN node 404 may inform the inter-RAN node 402 regarding a RAN node ID, associated with the second RAT RAN node 406, to which a message is to be forwarded. In this example, the first RAT RAN node 404 may transmit the message to the inter-RAN node 402, and the inter-RAN node 402 may forward the message to the second RAT RAN node 406 based at least in part on the RAN node ID associated with the second RAT RAN node 406. In this example, the first RAT RAN node 404 may be a source RAN node, the second RAT RAN node 406 may be a target RAN node, and the RAN node ID may be a target RAN node ID.

In some aspects, the first RAT RAN node 404 may indicate the target RAN node ID based at least in part on routing information or an XnAP message. The first RAT RAN node 404 may include the routing information in an existing XnAP message, where the routing information may include a source RAN node ID associated with the first RAT RAN node 404 and the target RAN node ID. Alternatively, the first RAT RAN node 404 may transmit the XnAP message to the inter-RAN node 402, where the XnAP message may include a routing header and existing XnAP messages as a container.

In some aspects, the second RAT RAN node 406 may inform the inter-RAN node 402 regarding a RAN node ID, associated with the first RAT RAN node 404, to which a message is to be forwarded. In this example, the second RAT RAN node 406 may transmit the message to the inter-RAN node 402, and the inter-RAN node 402 may forward the message to the first RAT RAN node 404 based at least in part on the RAN node ID associated with the first RAT RAN node 404. In this example, the second RAT RAN node 406 may be a source RAN node, the first RAT RAN node 404 may be a target RAN node, and the RAN node ID may be a target RAN node ID.

In some aspects, the second RAT RAN node 406 may indicate the target RAN node ID based at least in part on routing information or an SBI API call to the inter-RAN node 402. The second RAT RAN node 406 may include the routing information in the same SBI API call used to transmit control plane information to another second RAT RAN node, where the routing information may include a source RAN node ID associated with the second RAT RAN node 406 and the target RAN node ID. Alternatively, the second RAT RAN node 406 may make the SBI API call to the inter-RAN node 402, where the SBI API call may include a router header and contents relevant for control plane information sent to the first RAT RAN node 404.

In some aspects, the inter-RAN node 402 may register as an inter-RAN node service support with an NRF. The inter-RAN node 402 may may include discovered RAN node IDs in a registration message. The inter-RAN node 402 may indicate that such a service supports the communication between the first RAT RAN node 404 and the second RAT RAN node 406, where the first RAT RAN node 404 may support a first RAN-to-RAN interface type (e.g., PPI or XnAP) and the second RAT RAN node 406 may support a second RAN-to-RAN interface type (e.g., SBI).

In some aspects, the inter-RAN node 402 may receive a first message from the first RAT RAN node 404 via the first RAN-to-RAN interface type. The first message may indicate a source RAN node ID and a target RAN node ID. In this example, the source RAN node ID may be the first RAT RAN node 404 and the target RAN node ID may be the second RAT RAN node 406. The inter-RAN node 402 may convert the first message to a second message suitable for the second RAN-to-RAN interface type. A conversion may involve decoding the first message and using received information in the first message to determine the second RAN-to-RAN interface type. The conversion may involve a translation operation or a mapping operation, which may cause the second message to be derived from the first message. The inter-RAN node 402 may encode the second message in a format associated with the second RAN-to-RAN interface type. The inter-RAN node 402 may transmit the second message to the second RAT RAN node 406. In this example, the first message may be an XnAP message of an XnAP elementary procedure, and the second message may be an HTTP message.

In some aspects, the inter-RAN node 402 may receive a first message from the second RAT RAN node 406 via the second RAN-to-RAN interface type. The second message may indicate a source RAN node ID and a target RAN node ID. In this example, the source RAN node ID may be the second RAT RAN node 406 and the target RAN node ID may be the first RAT RAN node 404. The inter-RAN node 402 may convert the first message to a second message suitable for the first RAN-to-RAN interface type. A conversion may involve decoding the first message and using received information in the first message to determine the first RAN-to-RAN interface type. The inter-RAN node 402 may encode the second message in a format associated with the first RAN-to-RAN interface type. The inter-RAN node 402 may transmit the second message to the first RAT RAN node 404. In this example, the first message may be an HTTP message, and the second message may be an XnAP message.

In some aspects, the first RAT RAN node 404 may identify that a connection to the second RAT RAN node 406 is via the inter-RAN node 402 based at least in part on a RAT type of the second RAT RAN node 406. The first RAT RAN node 404 may encode messages sent to the second RAT RAN node 406 via the inter-RAN node 402 based at least in part on an interface type format. The first RAT RAN node 404 may transmit messages to be sent to the second RAT RAN node 406 to the inter-RAN node 402, where a message may indicate a source RAN node ID associated with the first RAT RAN node 404 and a target RAN node ID associated with the second RAT RAN node 406. The first RAT RAN node 404 may receive messages from the second RAT RAN node 406 via the inter-RAN node 402 based at least in part on the interface type format.

In some aspects, the second RAT RAN node 406 may identify that a connection to the first RAT RAN node 404 is via the inter-RAN node 402 based at least in part on a RAT type of the first RAT RAN node 404. The second RAT RAN node 406 may encode messages sent to the first RAT RAN node 404 via the inter-RAN node 402 based at least in part on an interface type format. The second RAT RAN node 406 may transmit messages to be sent to the first RAT RAN node 404 to the inter-RAN node 402, where a message may indicate a source RAN node ID associated with the second RAT RAN node 406 and a target RAN node ID associated with the first RAT RAN node 404. The second RAT RAN node 406 may receive messages from the first RAT RAN node 404 via the inter-RAN node 402 based at least in part on the interface type format.

In some aspects, the second RAT RAN node 406 may perform a neighbor RAN node discovery. The second RAT RAN node 406 may discover neighbor RAN nodes, which may include the first RAT RAN node 404, via an automatic neighbor relation (ANR) procedure with measurements. For example, the second RAT RAN node 406 may discover neighbor 5G RAN nodes via an ANR procedure with 5G measurements. The second RAT RAN node 406 may configure a UE with measurements to monitor and report neighbor cells (e.g., 5G neighbor cells). The neighbor cells may be associated with the neighbor RAN nodes. The UE may transmit measurement reports for the neighbor cells and a global cell ID report for the neighbor cells. The second RAT RAN node 406 may maintain an NCRT for the neighbor cells.

In some aspects, the second RAT RAN node 406 may perform an inter-RAN node discovery. The second RAT RAN node 406 may discover the inter-RAN node 402 to connect to in order to perform a communication with the first RAT RAN node 404. In some aspects, the inter-RAN node discovery may be based at least in part on a configuration from an OAM entity. The configuration may indicate one or more node IDs associated with a range of first RAT RAN IDs (e.g., 5G RAN IDs). The one or more node IDs may be indicated in a static manner. In some aspects, the inter-RAN node discovery may be based at least in part on UE reported node IDs corresponding to first RAT cells. A first RAT RAN connected node ID may be advertised in a first RAT SIB, which may be reported by the UE to a second RAT RAN as part of an ANR procedure. In some aspects, the inter-RAN node discovery may be based at least in part on a first RAT TNL ID discovery procedure via an AMF. In this example, the inter-RAN node 402 may register with the NRF, and the second RAT RAN node 406 may discover the inter-RAN node 402 that is registered with the NRF via the AMF. In some aspects, the inter-RAN node discovery may be based at least in part on an NRF service discovery procedure. In this example, the inter-RAN node 402 may register with the NRF and report connected first RAT RAN node IDs. The second RAT RAN node 406 may discover the inter-RAN node 402 via the NRF, and the second RAT RAN node 406 may register with the inter-RAN node 402. In some aspects, the inter-RAN node discovery may be performed indirectly via a node registration with the second RAT RAN node 406. In this example, the inter-RAN node 402 may discover the second RAT RAN node 406 via the NRF. The inter-RAN node 402 may register with the second RAT RAN node 406.

In some aspects, the second RAT RAN node 406 may configure the UE with measurements to monitor and report the neighbor cells. The second RAT RAN node 406 may receive, from the UE, a UE measurement report. The UE measurement report may indicate neighbor cell information for a neighbor cell (e.g., a 5G neighbor cell). In this example, the neighbor cell may be associated with the first RAT RAN node 404. The second RAT RAN node 406 may discover the inter-RAN node 402, which may be connected to the first RAT RAN node 404. The second RAT RAN node 406 may use an NRF (e.g., DNS) to discover a node ID associated with the inter-RAN node 402. The second RAT RAN node 406 may register with the inter-RAN node 402 over SBI. The second RAT RAN node 406 may communicate with the first RAT RAN node 404, which may correspond to the neighbor cell, via the inter-RAN node 402.

As indicated above, FIG. 4 is provided as an example. Other examples may differ from what is described with regard to FIG. 4.

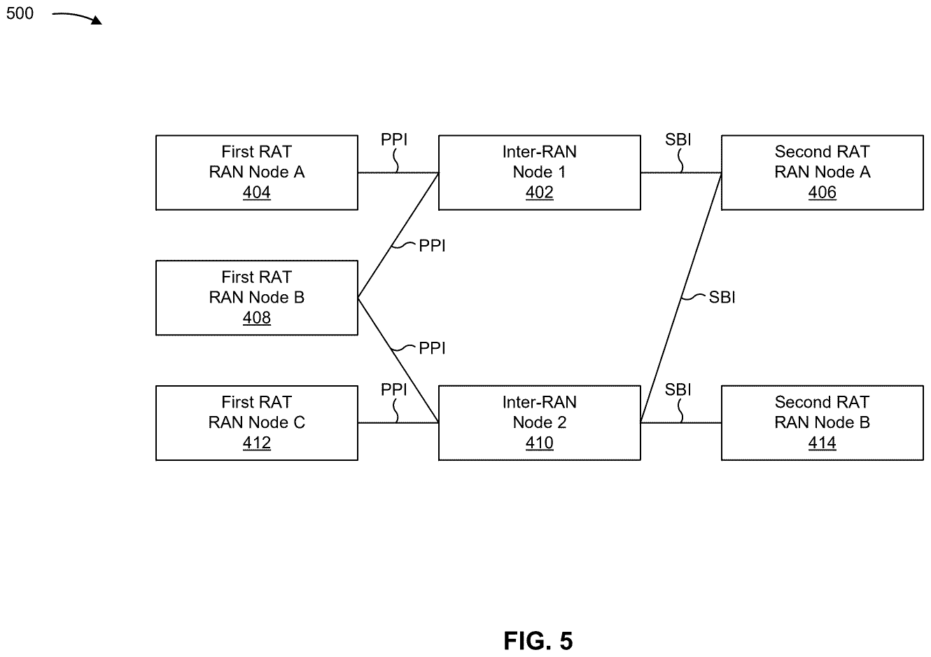

FIG. 5 is a diagram illustrating an example 500 associated with multiple inter-RAN nodes in a wireless network.

As shown in FIG. 5, inter-RAN node 1 402 may be connected to first RAT RAN node A 404 via PPI, and the inter-RAN node 1 402 may be connected to second RAT RAN node A 406 via SBI. First RAT RAN node B 408 may be connected to the inter-RAN node 1 402 via PPI, and the first RAT RAN node B 408 may be connected to inter-RAN node 2 410 via PPI. The inter-RAN node 2 410 may be connected to first RAT RAN node C 412 via PPI, and the inter-RAN node 2 410 may be connected to second RAT RAN node B 414 via SBI. The inter-RAN node 2 410 may be connected to the second RAT RAN node A 406 via SBI.

In this example, a first RAT may be associated with 4G or 5G, and a second RAT may be associated with 6G. The first RAT may be associated with a legacy RAN node, and the second RAT may be associated with a non-legacy RAN node. In other words, the legacy RAN node may be a 4G/5G RAN node, and the non-legacy RAN node may be a 6G RAN node.

In some aspects, in a wireless network, such as a 6G network, more than one inter-RAN node may be supported. No interface may be supported between inter-RAN nodes. A pair of RAN nodes (e.g., a first RAT RAN node and a second RAT RAN node) may communicate via an inter-RAN adaptor (e.g., only one inter-RAN node). Different UE associated procedures terminating with the pair of RAN nodes may be supported via the inter-RAN adaptor (e.g., only one inter-RAN node). The first RAT RAN node and the second RAT RAN node may connect to more than one inter-RAN node to support communication among different RAN node pairs.

In some aspects, the inter-RAN node may appear to the first RAT RAN node as a peer second RAT RAN node on a radio network layer (RNL) (e.g., to introduce additional application protocol information). Alternatively, the inter-RAN node may appear to the first RAT RAN node as a peer first RAT RAN node on a TNL (e.g., from a transport connection setup). In some aspects, the inter-RAN node may appear to the second RAT RAN node as a peer first RAT RAN node on an RNL (e.g., to introduce additional application protocol information). Alternatively, the inter-RAN node may appear to the second RAT RAN node as a peer second RAT RAN node on a TNL (e.g., from a transport connection setup).

As indicated above, FIG. 5 is provided as an example. Other examples may differ from what is described with regard to FIG. 5.

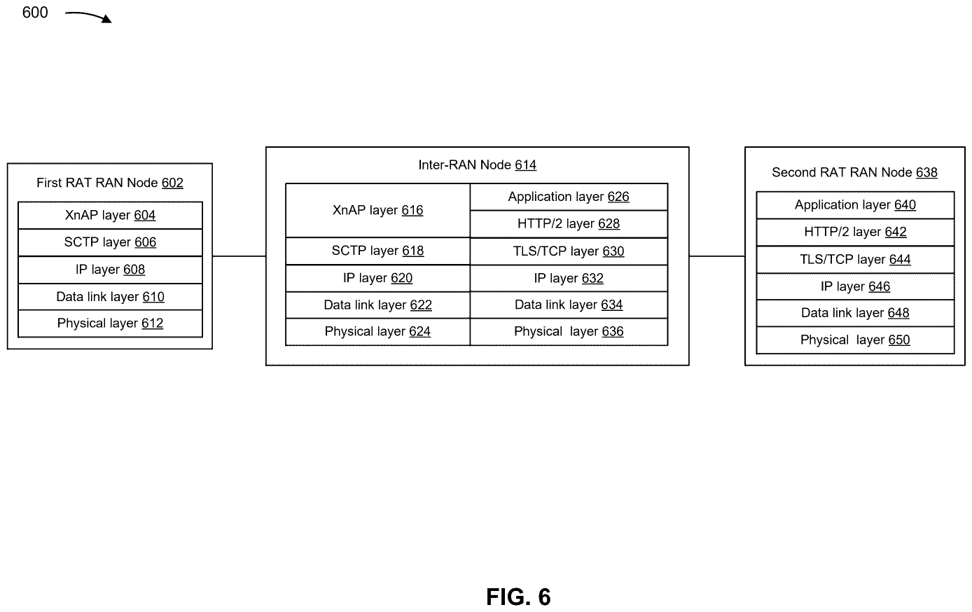

FIG. 6 is a diagram illustrating an example 600 associated with a control plane protocol stack.

As shown in FIG. 6, in a control plane protocol stack, a first RAT RAN node 602 may include an XnAP layer 604, an SCTP layer 606, an Internet Protocol (IP) layer 608, a data link layer 610, and a physical layer 612. The XnAP layer 604 may be associated with an RNL. The SCTP layer 606, the IP layer 608, the data link layer 610, and the physical layer 612 may be associated with a TNL. A second RAT RAN node 638 may include an application layer 640, an HTTP/2 layer 642, a TLS/TCP layer 644, an IP layer 646, a data link layer 648, and a physical layer 650. The application layer 640 may be associated with an RNL. The HTTP/2 layer 642, the TLS/TCP layer 644, the IP layer 646, the data link layer 648, and the physical layer 650 may be associated with a TNL. An inter-RAN node 614 may include an XnAP layer 616, an SCTP layer 618, an IP layer 620, a data link layer 622, and a physical layer 624. The inter-RAN node 614 may also include an application layer 626, an HTTP/2 layer 628, a TLS/TCP layer 630, an IP layer 632, a data link layer 634, and a physical layer 636. The first RAT RAN node 602 may communicate with the inter-RAN node 614 via PPI, and the second RAT RAN node 638 may communicate with the inter-RAN node 614 via SBI.

As indicated above, FIG. 6 is provided as an example. Other examples may differ from what is described with regard to FIG. 6.

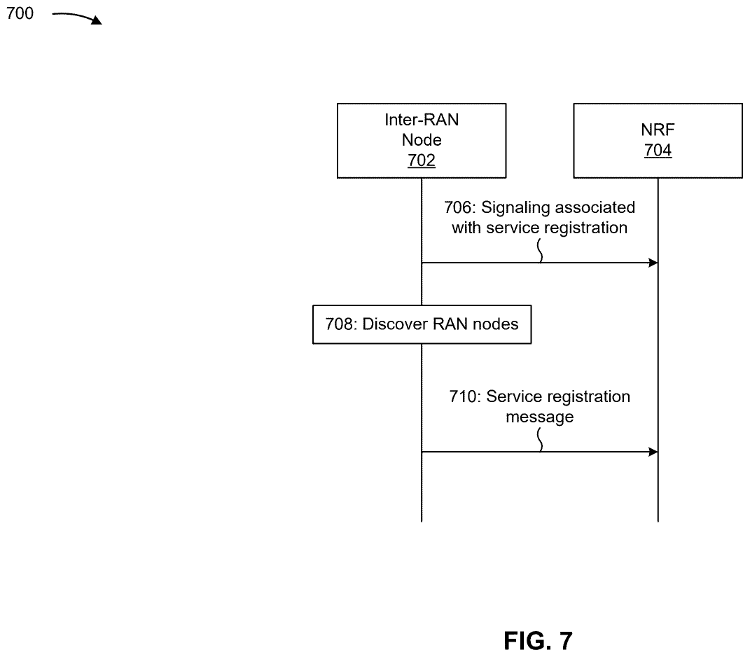

FIG. 7 is a diagram illustrating an example 700 associated with a node service registration. As shown in FIG. 7, example 700 includes communication between an inter-RAN node 702 and an NRF 704. In some aspects, the inter-RAN node 702 and the NRF 704 may be included in a wireless network, such as wireless network 100. The NRF 704 may be a 6G NRF.

As shown by reference number 706, as part of an inter-RAN node service registration, the inter-RAN node 702 may transmit signaling to the NRF 704, where the signaling may be associated with a network function (NF) service register. The inter-RAN node 702 may register as an inter-RAN node service with the NRF 704. The signaling associated with a registration may indicate a node ID, 5G global network node IDs, 6G global RAN IDs, 5G cell global identities (CGIs), or 6G CGIs.

As shown by reference number 708, the inter-RAN node 702 may discover RAN nodes, which may include first RAT RAN nodes and second RAT RAN nodes. The inter-RAN node 702 may discover the RAN nodes via the NRF 704. The inter-RAN node 702 may discover RAN node IDs using a RAN node discovery procedure. For example, the inter-RAN node 702 may discover connected 5G/6G RAN node IDs using a 5G/6G RAN node discovery procedure.

As shown by reference number 710, the inter-RAN node 702 may transmit a service registration message to the NRF 704. The service registration message may indicate discovered RAN node IDs. The discovered RAN node IDs may include 5G global network node IDs or 6G global RAN IDs. The discovered RAN node IDs may include 5G CGIs or 6G CGIs. The inter-RAN node 702 may transmit the service registration message in order to update the registration with the NRF 704. The inter-RAN node 702 may update the registration with the NRF 704 in order to add or remove the discovered RAN IDs based at least in part on RAN node discovery updates.

As indicated above, FIG. 7 is provided as an example. Other examples may differ from what is described with regard to FIG. 7.

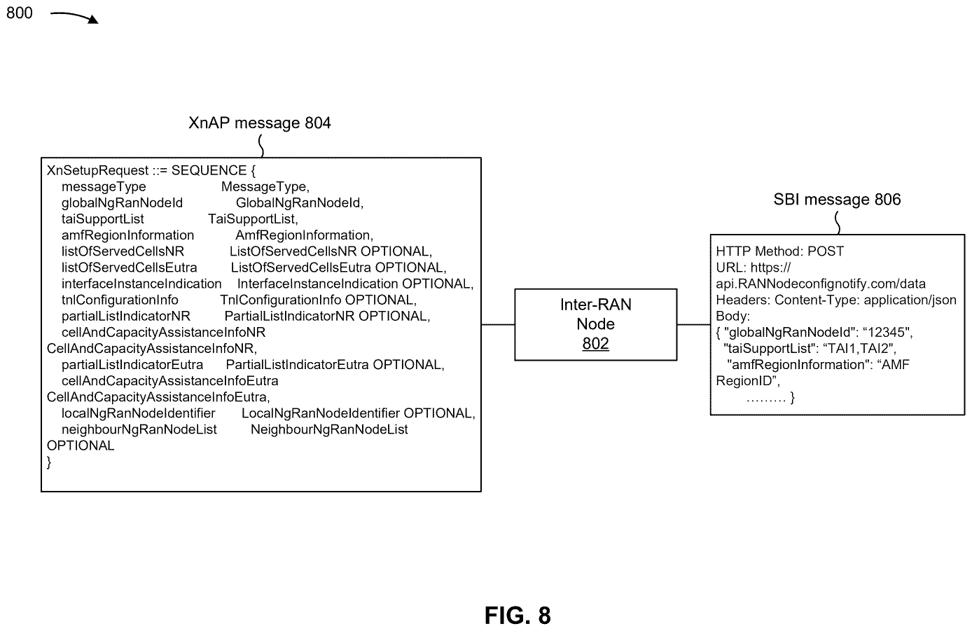

FIG. 8 is a diagram illustrating an example 800 associated with a protocol conversion.

As shown in FIG. 8, an inter-RAN node 802 may be capable of a PPI-SBI protocol conversion. The inter-RAN node 802 may convert an SBI message 804 (e.g., an SBI API call) into an XnAP message 806, or alternatively, the inter-RAN node 802 may convert the XnAP message 806 into the SBI message 804. A conversion operation may include a translation operation or a mapping operation. The inter-RAN node 802 may decode contents of the SBI message 804 (e.g., an HTTP message) and prepare the XnAP message 806 corresponding to the SBI message 804. Alternatively, the inter-RAN node 802 may decode contents of the XnAP message 806 and prepare the SBI message 804 corresponding to the XnAP message 806. The inter-RAN node 802 may encode and/or decode abstract syntax notation (ASN.1), JSON, or any other application layer encoding chosen for the SBI.

As indicated above, FIG. 8 is provided as an example. Other examples may differ from what is described with regard to FIG. 8.

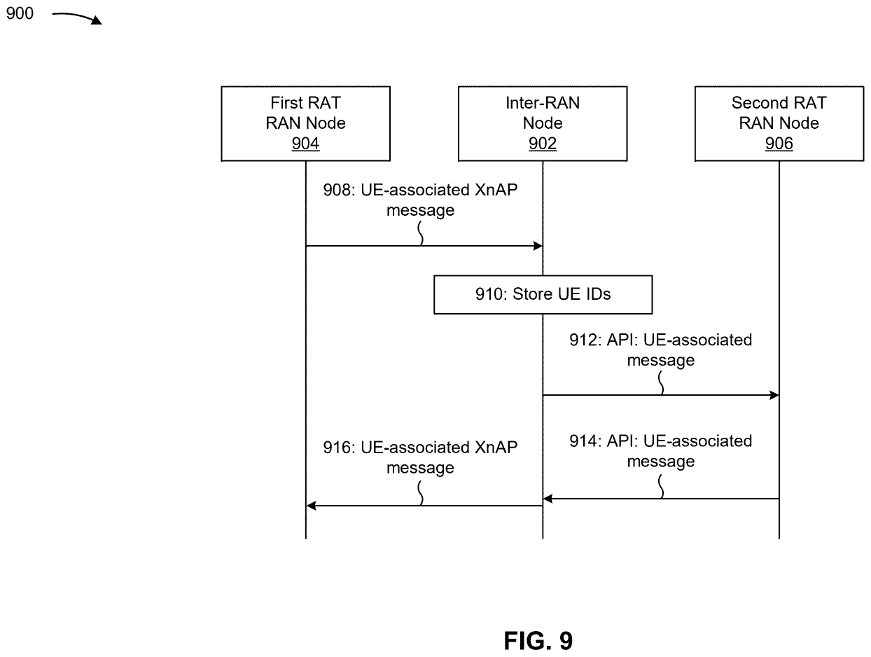

FIG. 9 is a diagram illustrating an example 900 associated with UE-associated message routing. As shown in FIG. 9, example 900 includes communication between an inter-RAN node 902, a first RAT RAN node 904, and a second RAT RAN node 906. In some aspects, the inter-RAN node 902, the first RAT RAN node 904, and the second RAT RAN node 906 may be included in a wireless network, such as wireless network 100.

In some aspects, the first RAT RAN node 904 may be a source RAN node, such as a source 4G/5G RAN node. The second RAT RAN node 906 may be a target RAN node, such as a target 6G RAN node.

As shown by reference number 908, as part of a UE-associated message routing, the first RAT RAN node 904 may transmit a UE-associated XnAP message to the inter-RAN node 902. The UE-associated XnAP message may indicate routing information. The routing information may indicate a source RAN node ID and a target RAN node ID. The UE-associated XnAP message may indicate a source RAN UE XnAP ID. The UE-associated XnAP message may indicate message content. The first RAT RAN node 904 may assign a UE XnAP ID or a UE 6G SBI application protocol (AP) ID for a UE-associated logical connection with the second RAT RAN node 906 (e.g., a peer RAN node).

As shown by reference number 910, the inter-RAN node 902 may store UE IDs for the first RAT RAN node 904. The inter-RAN node 902 may store UE-associated logical Xn-connection IDs for a 5G Xn interface and a 6G SBI with a 6G RAN. The inter-RAN node 902 may associate the UE XnAP ID and a 5G RAN node ID with a corresponding 6G RAN node ID and a UE 6G SBI AP ID.

As shown by reference number 912, the inter-RAN node 902 may transmit, via an API, a UE-associated message to the second RAT RAN node 906. The UE-associated message may indicate routing information. The routing information may indicate the source RAN node ID and the target RAN node ID. The UE-associated message may indicate the source RAN UE XnAP ID. The UE-associated message may indicate the message content. In other words, the inter-RAN node 902 may forward UE IDs to the second RAT RAN node 906.

As shown by reference number 914, the second RAT RAN node 906 may transmit, via an API, a UE-associated message to the inter-RAN node 902. The UE-associated message may indicate routing information. The routing information may indicate the source RAN node ID and the target RAN node ID. The UE-associated message may indicate the source RAN UE XnAP ID. The UE-associated message may indicate a target RAN UE 6G SBI AP ID. The UE-associated message may indicate message content.

As shown by reference number 916, the inter-RAN node 902 may transmit, to the first RAT RAN node 904, a UE-associated XnAP message. The UE-associated XnAP message may indicate routing information. The routing information may indicate the source RAN node ID and the target RAN node ID. The UE-associated XnAP message may indicate the source RAN UE XnAP ID. The UE-associated XnAP message may indicate a target RAN UE 6G SBI AP ID. The UE-associated XnAP message may indicate message content.

As indicated above, FIG. 9 is provided as an example. Other examples may differ from what is described with regard to FIG. 9.

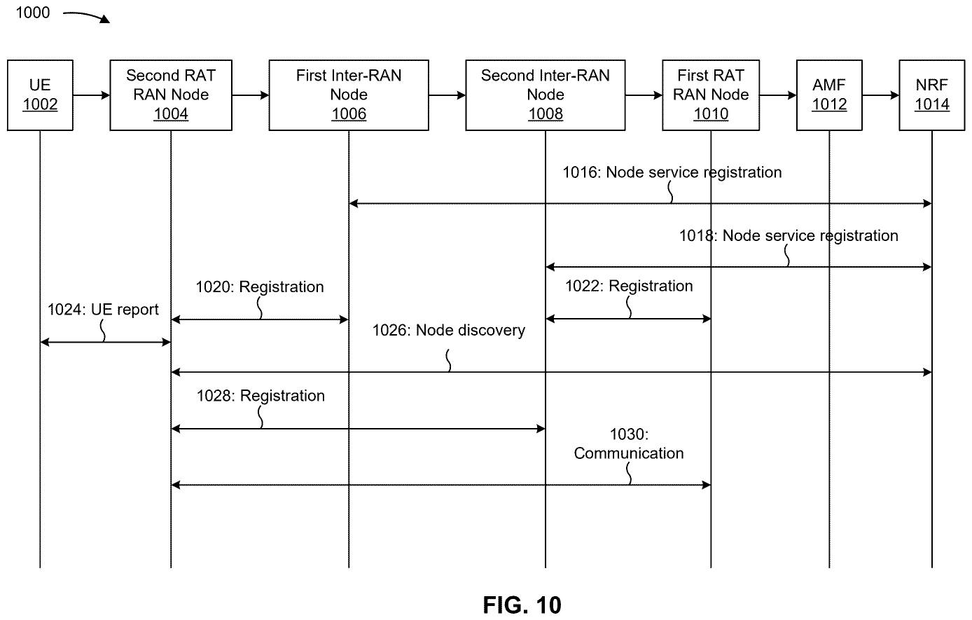

FIG. 10 is a diagram illustrating an example 1000 associated with communication via an inter-RAN node. As shown in FIG. 10, example 1000 includes communication between a UE 1002, a second RAT RAN node 1004, a first inter-RAN node 1006, a second inter-RAN node 1008, a first RAT RAN node 1010, an AMF 1012, and an NRF 1014. In some aspects, the UE 1002, the second RAT RAN node 1004, the first inter-RAN node 1006, the second inter-RAN node 1008, the first RAT RAN node 1010, the AMF 1012, and the NRF 1014 may be included in a wireless network, such as wireless network 100.

As shown by reference number 1016, the first inter-RAN node 1006 may perform a node service registration with the NRF 1014. The node service registration may involve exchanging signaling in order to register the first inter-RAN node 1006 with the NRF 1014. As shown by reference number 1018, the second inter-RAN node 1008 may perform a node service registration with the NRF 1014. The node service registration may involve exchanging signaling in order to register the second inter-RAN node 1008 with the NRF 1014.

As shown by reference number 1020, the second RAT RAN node 1004 may perform a registration with the first inter-RAN node 1006 via SBI. The registration may involve exchanging signaling in order to register the second RAT RAN node 1004 with the first inter-RAN node 1006. As shown by reference number 1022, the first RAT RAN node 1010 may perform a registration with the second inter-RAN node 1008 via PPI/Xn. The registration may involve exchanging signaling in order to register the first RAT RAN node 1010 with the second inter-RAN node 1008.

As shown by reference number 1024, the UE 1002 may transmit a report to the second RAT RAN node 1004. The report may indicate one or more neighbor cells, which may include a neighbor cell associated with the first RAT RAN node 1010. As shown by reference number 1026, the second RAT RAN node 1004 may discover the second inter-RAN node 1008, which may be connected to the first RAT RAN node 1010. Such a discovery may involve signaling between the second RAT RAN node 1004 and the NRF 1014. In other words, the second RAT RAN node 1004 may use the NRF 1014 in order to discover a node ID associated with the second inter-RAN node 1008.

As shown by reference number 1028, the second RAT RAN node 1004 may perform a registration with the second inter-RAN node 1008 via SBI. The registration may involve exchanging signaling in order to register the second RAT RAN node 1004 with the second inter-RAN node 1008. As shown by reference number 1030, the second RAT RAN node 1004 may communicate with the first RAT RAN node 1010 via the second inter-RAN node 1008.

In some aspects, the second RAT RAN node 1004 may determine to communicate with the first RAT RAN node 1010 for inter-RAT dual connectivity, inter-RAT handover, or another procedure. The second RAT RAN node 1004 may support a control plane communication with the first RAT RAN node 1010 via the second inter-RAN node 1008. Multiple nodes, such as the first inter-RAN node 1006 and the second inter-RAN node 1008 may be supported in the wireless network. The second RAT RAN node 1004 may set up connections to additional inter-RAN nodes when the first RAT RAN node 1010 is not reachable via the second inter-RAN node 1008.

As indicated above, FIG. 10 is provided as an example. Other examples may differ from what is described with regard to FIG. 10.

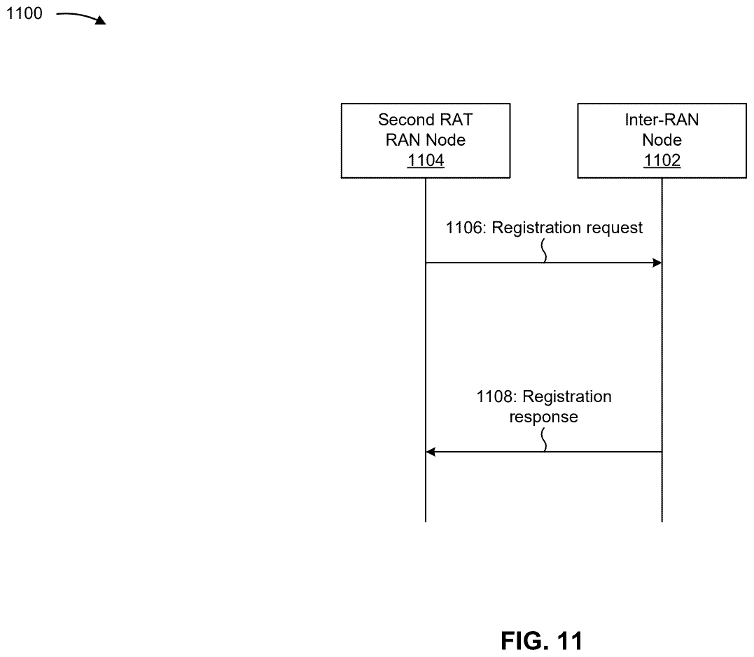

FIG. 11 is a diagram illustrating an example 1100 associated with a node registration. As shown in FIG. 11, example 1100 includes communication between an inter-RAN node 1102 and a second RAT RAN node 1104. In some aspects, the inter-RAN node 1102 and the second RAT RAN node 1104 may be included in a wireless network, such as wireless network 100.

As shown by reference number 1106, the second RAT RAN node 1104 may transmit, via an API to the inter-RAN node 1102, a registration request. The registration request may indicate a global Next Generation (NG)-RAN node ID. The second RAT RAN node 1104 may register with the inter-RAN node 1102. As shown by reference number 1108, the inter-RAN node 1102 may transmit, via an API to the second RAT RAN node 1104, a registration response. The registration response may indicate a global inter-RAN node ID and message content. The second RAT RAN node 1104 may receive the registration response, which may include the global inter-RAN node ID and connected RAN node IDs. The connected RAN node IDs may include a 5G global network node ID, a 6G global RAN ID, 5G CGIs, and/or 6G CGIs. The second RAT RAN node 1104 may support a registration removal request/response procedure to remove its entry with the inter-RAN node 1102. The second RAT RAN node 1104 may indicate the global NG-RAN node ID, an interface instance indication, and/or a removal threshold during the registration removal request/response procedure.

As indicated above, FIG. 11 is provided as an example. Other examples may differ from what is described with regard to FIG. 11.

FIG. 12 is a diagram illustrating an example process 1200 performed, for example, at an inter-RAN node or an apparatus of an inter-RAN node. Example process 1200 is an example where the apparatus or the inter-RAN node (e.g., inter-RAN node 122) performs operations associated with relaying messages between RAN nodes.

As shown in FIG. 12, in some aspects, process 1200 may include receiving a first message from a first RAT RAN node via a first interface (block 1210). For example, the inter-RAN node (e.g., using reception component 1402 or communication manager 1406, depicted in FIG. 14) may receive a first message from a first RAT RAN node via a first interface, as described above.

As further shown in FIG. 12, in some aspects, process 1200 may include converting the first message to a second message that is associated with a second interface (block 1220). For example, the inter-RAN node (e.g., using communication manager 1406, depicted in FIG. 14) may convert the first message to a second message that is associated with a second interface, as described above.

As further shown in FIG. 12, in some aspects, process 1200 may include transmitting the second message to a second RAT RAN node via the second interface (block 1230). For example, the inter-RAN node (e.g., using transmission component 1404 or communication manager 1406, depicted in FIG. 14) may transmit the second message to a second RAT RAN node via the second interface, as described above.

Process 1200 may include additional aspects, such as any single aspect or any combination of aspects described below or in connection with one or more other processes described elsewhere herein.

In a first aspect, process 1200 includes receiving a third message from the second RAT RAN node via the second interface, converting the third message to a fourth message that is suitable for the first interface, and transmitting the fourth message to the first RAT RAN node via the first interface.

In a second aspect, alone or in combination with the first aspect, the first RAT RAN node is a legacy RAN node, wherein the second RAT RAN node is a non-legacy RAN node, wherein the first interface is a PPI, wherein the second interface is an SBI, wherein the first message is an Xn application protocol message, and the second message is an HTTP message.

In a third aspect, alone or in combination with one or more of the first and second aspects, the first RAT RAN node is a non-legacy RAN node, wherein the second RAT RAN node is a legacy RAN node, wherein the first interface is an SBI, wherein the second interface is a PPI, wherein the first message is an HTTP message, and the second message is an XnAP message.

In a fourth aspect, alone or in combination with one or more of the first through third aspects, the first message indicates a source RAN node ID associated with the first RAT RAN node and a target RAN node ID associated with the second RAT RAN node.

In a fifth aspect, alone or in combination with one or more of the first through fourth aspects, process 1200 includes transmitting, to an NRF, a registration message for registering as an inter-RAN node service support with the NRF, wherein the registration message indicates one or more discovered RAN node IDs, and the inter-RAN node service support is for communications between RAN nodes associated with different RATs and different interface types.

In a sixth aspect, alone or in combination with one or more of the first through fifth aspects, process 1200 includes decoding the first message, determining the second interface based at least in part on information indicated in the first message, and encoding the second message in accordance with the second interface.

In a seventh aspect, alone or in combination with one or more of the first through sixth aspects, the first message and the second message are control plane messages.

In an eighth aspect, alone or in combination with one or more of the first through seventh aspects, the inter-RAN node is a first inter-RAN node in a wireless network, and the wireless network includes a second inter-RAN node.

In a ninth aspect, alone or in combination with one or more of the first through eighth aspects, process 1200 includes discovering a RAN node TNL ID associated with the second RAT RAN node, maintaining a mapping table that includes the RAN node TNL ID and a corresponding RAN node ID, and routing traffic between the first RAT RAN node and the second RAT RAN node based at least in part on the mapping table and routing information provided by one or more of the first RAT RAN node or the second RAT RAN node.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, at a second RAT RAN node or an apparatus of a second RAT RAN node. Example process 1300 is an example where the apparatus or the second RAT RAN node (e.g., second RAT RAN node 126) performs operations associated with relaying messages between RAN nodes.

As shown in FIG. 13, in some aspects, process 1300 may include discovering an inter-RAN node associated with a first RAT RAN node (block 1310). For example, the second RAT RAN node (e.g., using communication manager 1506, depicted in FIG. 15) may discover an inter-RAN node associated with a first RAT RAN node, as described above.

As further shown in FIG. 13, in some aspects, process 1300 may include registering the second RAT RAN node with the inter-RAN node (block 1320). For example, the second RAT RAN node (e.g., using communication manager 1506, depicted in FIG. 15) may register the second RAT RAN node with the inter-RAN node, as described above.

As further shown in FIG. 13, in some aspects, process 1300 may include communicating with the first RAT RAN node via the inter-RAN node (block 1330). For example, the second RAT RAN node (e.g., using reception component 1502, transmission component 1504, or communication manager 1506, depicted in FIG. 15) may communicate with the first RAT RAN node via the inter-RAN node, as described above.

Process 1300 may include additional aspects, such as any single aspect or any combination of aspects described below or in connection with one or more other processes described elsewhere herein.

In a first aspect, communicating with the first RAT RAN node comprises transmitting a control plane message to the first RAT RAN node, wherein the control plane message is a non-UE-associated message or a UE-associated message, wherein the control plane message indicates a source RAN node ID associated with the second RAT RAN node and a target RAN node ID associated with the first RAT RAN node.

In a second aspect, alone or in combination with the first aspect, the first RAT RAN node is a legacy RAN node associated with a first interface, wherein the second RAT RAN node is a non-legacy RAN node associated with a second interface, wherein the first interface is a PPI, and the second interface is an SBI.

In a third aspect, alone or in combination with one or more of the first and second aspects, process 1300 includes transmitting, to a UE, a measurement configuration to monitor and report measurements associated with one or more first RAT neighbor cells, and receiving, from the UE, a measurement report based at least in part on the measurement configuration, wherein the measurement report includes information associated with the first RAT RAN node, and the inter-RAN node is discovered based at least in part on the first RAT RAN node.

In a fourth aspect, alone or in combination with one or more of the first through third aspects, process 1300 includes transmitting signaling to an NRF to identify a node ID associated with the inter-RAN node.

In a fifth aspect, alone or in combination with one or more of the first through fourth aspects, process 1300 includes maintaining an NCRT that indicates a first RAT cell that is associated with the first RAT RAN node, wherein the NCRT is based at least in part on one or more measurement reports for one or more first RAT neighbor cells.

In a sixth aspect, alone or in combination with one or more of the first through fifth aspects, the inter-RAN node is discovered based at least in part on a configuration received from an OAM entity, wherein the configuration indicates one or more node IDs associated with a range of first RAT RAN node IDs.

In a seventh aspect, alone or in combination with one or more of the first through sixth aspects, the inter-RAN node is discovered based at least in part on one or more UE-reported node IDs corresponding to one or more first RAT cells.

In an eighth aspect, alone or in combination with one or more of the first through seventh aspects, the inter-RAN node is discovered based at least in part on a first RAT TNL ID discovery via an AMF.

In a ninth aspect, alone or in combination with one or more of the first through eighth aspects, the inter-RAN node is discovered based at least in part on an NRF service discovery.

In a tenth aspect, alone or in combination with one or more of the first through ninth aspects, process 1300 includes obtaining information associated with the inter-RAN node as part of an inter-RAN node registration with the second RAT RAN node.

In an eleventh aspect, alone or in combination with one or more of the first through tenth aspects, process 1300 includes transmitting, to the inter-RAN node, a registration request that indicates a global RAN node ID associated with the second RAT RAN node, and receiving, from the inter-RAN node and based at least in part on the registration request, a registration response that indicates a global inter-RAN node ID associated with the inter-RAN node.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram of an example apparatus 1400 for wireless communication. The apparatus 1400 may be an inter-RAN node, or an inter-RAN node may include the apparatus 1400. In some aspects, the apparatus 1400 includes a reception component 1402, a transmission component 1404, or a communication manager 1406, which may be in communication with one another (for example, via one or more buses or one or more other components). In some aspects, the communication manager 1406 is the communication manager 150 described in connection with FIG. 1. As shown, the apparatus 1400 may communicate with another apparatus 1408, such as a UE or a network node (such as a CU, a DU, an RU, or a base station), using the reception component 1402 and the transmission component 1404. The communication manager 1406 may be included in, or implemented via, a processing system of the inter-RAN node.

In some aspects, the apparatus 1400 may be configured to perform one or more operations described herein in connection with FIGS. 4-11. Additionally, or alternatively, the apparatus 1400 may be configured to perform one or more processes described herein, such as process 1200 of FIG. 12. In some aspects, the apparatus 1400 or one or more components shown in FIG. 14 may include one or more components of the inter-RAN node described in connection with FIG. 1. Additionally, or alternatively, one or more components shown in FIG. 14 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications, and may provide the processed signals to the one or more other components of the apparatus 1400. In some aspects, the reception component 1402 may include one or more components of the inter-RAN node described above in connection with FIG. 1, such as a radio, one or more RF chains, one or more transceivers, or one or more modems, each of which may in turn be coupled with one or more antennas of the inter-RAN node.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications, and may transmit the processed signals to the apparatus 1408. In some aspects, the transmission component 1404 may include one or more components of the inter-RAN node described above in connection with FIG. 1, such as a radio, one or more RF chains, one or more transceivers, or one or more modems, each of which may in turn be coupled with one or more antennas of the inter-RAN node described in connection with FIG. 1. In some aspects, the transmission component 1404 may be co-located with the reception component 1402.

The communication manager 1406 may support operations of the reception component 1402 or the transmission component 1404. For example, the communication manager 1406 may receive information associated with configuring reception of communications by the reception component 1402 or transmission of communications by the transmission component 1404. Additionally, or alternatively, the communication manager 1406 may generate or provide control information to the reception component 1402 or the transmission component 1404 to control reception or transmission of communications.

The reception component 1402 may receive a first message from a first RAT RAN node via a first interface. The communication manager 1406 may convert the first message to a second message that is associated with a second interface. The transmission component 1404 may transmit the second message to a second RAT RAN node via the second interface.

The reception component 1402 may receive a third message from the second RAT RAN node via the second interface. The communication manager 1406 may convert the third message to a fourth message that is suitable for the first interface. The transmission component 1404 may transmit the fourth message to the first RAT RAN node via the first interface. The transmission component 1404 may transmit, to an NRF, a registration message for registering as an inter-RAN node service support with the NRF, wherein the registration message indicates one or more discovered RAN node IDs, and the inter-RAN node service support is for communications between RAN nodes associated with different RATs and different interface types. The communication manager 1406 may decode the first message. The communication manager 1406 may determine the second interface based at least in part on information indicated in the first message. The communication manager 1406 may encode the second message in accordance with the second interface.

The communication manager 1406 may discover a RAN node TNL ID associated with the second RAT RAN node. The communication manager 1406 may maintain a mapping table that includes the RAN node TNL ID and a corresponding RAN node ID. The communication manager 1406 may route traffic between the first RAT RAN node and the second RAT RAN node based at least in part on the mapping table and routing information provided by one or more of the first RAT RAN node or the second RAT RAN node.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

FIG. 15 is a diagram of an example apparatus 1500 for wireless communication. The apparatus 1500 may be a second RAT RAN node, or a second RAT RAN node may include the apparatus 1500. In some aspects, the apparatus 1500 includes a reception component 1502, a transmission component 1504, or a communication manager 1506, which may be in communication with one another (for example, via one or more buses or one or more other components). In some aspects, the communication manager 1506 is the communication manager 155 described in connection with FIG. 1. As shown, the apparatus 1500 may communicate with another apparatus 1508, such as a UE or a network node (such as a CU, a DU, an RU, or a base station), using the reception component 1502 and the transmission component 1504. The communication manager 1506 may be included in, or implemented via, a processing system of the second RAT RAN node.

In some aspects, the apparatus 1500 may be configured to perform one or more operations described herein in connection with FIGS. 4-11. Additionally, or alternatively, the apparatus 1500 may be configured to perform one or more processes described herein, such as process 1300 of FIG. 13. In some aspects, the apparatus 1500 or one or more components shown in FIG. 15 may include one or more components of the second RAT RAN node described in connection with FIG. 1. Additionally, or alternatively, one or more components shown in FIG. 15 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1502 may receive communications, such as reference signals, control information, data communications, or a combination thereof, from the apparatus 1508. The reception component 1502 may provide received communications to one or more other components of the apparatus 1500. In some aspects, the reception component 1502 may perform signal processing on the received communications, and may provide the processed signals to the one or more other components of the apparatus 1500. In some aspects, the reception component 1502 may include one or more components of the second RAT RAN node described above in connection with FIG. 1, such as a radio, one or more RF chains, one or more transceivers, or one or more modems, each of which may in turn be coupled with one or more antennas of the second RAT RAN node.

The transmission component 1504 may transmit communications, such as reference signals, control information, data communications, or a combination thereof, to the apparatus 1508. In some aspects, one or more other components of the apparatus 1500 may generate communications and may provide the generated communications to the transmission component 1504 for transmission to the apparatus 1508. In some aspects, the transmission component 1504 may perform signal processing on the generated communications, and may transmit the processed signals to the apparatus 1508. In some aspects, the transmission component 1504 may include one or more components of the second RAT RAN node described above in connection with FIG. 1, such as a radio, one or more RF chains, one or more transceivers, or one or more modems, each of which may in turn be coupled with one or more antennas of the second RAT RAN node described in connection with FIG. 1. In some aspects, the transmission component 1504 may be co-located with the reception component 1502.

The communication manager 1506 may support operations of the reception component 1502 or the transmission component 1504. For example, the communication manager 1506 may receive information associated with configuring reception of communications by the reception component 1502 or transmission of communications by the transmission component 1504. Additionally, or alternatively, the communication manager 1506 may generate or provide control information to the reception component 1502 or the transmission component 1504 to control reception or transmission of communications.

The communication manager 1506 may discover an inter-RAN node associated with a first RAT RAN node. The communication manager 1506 may register the second RAT RAN node with the inter-RAN node. The reception component 1502 or the transmission component 1504 may communicate with the first RAT RAN node via the inter-RAN node.

The transmission component 1504 may transmit a control plane message to the first RAT RAN node, wherein the control plane message is a non-UE-associated message or a UE-associated message, and the control plane message indicates a source RAN node ID associated with the second RAT RAN node and a target RAN node ID associated with the first RAT RAN node. The transmission component 1504 may transmit, to a UE, a measurement configuration to monitor and report measurements associated with one or more first RAT neighbor cells. The reception component 1502 may receive, from the UE, a measurement report based at least in part on the measurement configuration, wherein the measurement report includes information associated with the first RAT RAN node, and the inter-RAN node is discovered based at least in part on the first RAT RAN node.

The transmission component 1504 may transmit signaling to an NRF to identify a node ID associated with the inter-RAN node. The communication manager 1506 may maintain an NCRT that indicates a first RAT cell that is associated with the first RAT RAN node, wherein the NCRT is based at least in part on one or more measurement reports for one or more first RAT neighbor cells. The communication manager 1506 may obtain information associated with the inter-RAN node as part of an inter-RAN node registration with the second RAT RAN node. The transmission component 1504 may transmit, to the inter-RAN node, a registration request that indicates a global RAN node ID associated with the second RAT RAN node. The reception component 1502 may receive, from the inter-RAN node and based at least in part on the registration request, a registration response that indicates a global inter-RAN node ID associated with the inter-RAN node.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

The following provides an overview of some Aspects of the present disclosure:

Aspect 1: A method of wireless communication performed by an inter-radio-access-network (RAN) node, comprising: receiving a first message from a first radio access technology (RAT) RAN node via a first interface; converting the first message to a second message that is associated with a second interface; and transmitting the second message to a second RAT RAN node via the second interface.

Aspect 2: The method of Aspect 1, further comprising: receiving a third message from the second RAT RAN node via the second interface; converting the third message to a fourth message that is suitable for the first interface; and transmitting the fourth message to the first RAT RAN node via the first interface.

Aspect 3: The method of any of Aspects 1-2, wherein the first RAT RAN node is a legacy RAN node, wherein the second RAT RAN node is a non-legacy RAN node, wherein the first interface is a point-to-point interface, wherein the second interface is a service-based interface, wherein the first message is an Xn application protocol message, and wherein the second message is a hypertext transfer protocol message.

Aspect 4: The method of any of Aspects 1-3, wherein the first RAT RAN node is a non-legacy RAN node, wherein the second RAT RAN node is a legacy RAN node, wherein the first interface is a service-based interface, wherein the second interface is a point-to-point interface, wherein the first message is a hypertext transfer protocol message, and wherein the second message is an Xn application protocol message.

Aspect 5: The method of any of Aspects 1-4, wherein the first message indicates a source RAN node identifier (ID) associated with the first RAT RAN node and a target RAN node ID associated with the second RAT RAN node.

Aspect 6: The method of any of Aspects 1-5, further comprising: transmitting, to a network repository function (NRF), a registration message for registering as an inter-RAN node service support with the NRF, wherein the registration message indicates one or more discovered RAN node identifiers, and wherein the inter-RAN node service support is for communications between RAN nodes associated with different RATs and different interface types.

Aspect 7: The method of any of Aspects 1-6, wherein converting the first message to the second message comprises: decoding the first message; determining the second interface based at least in part on information indicated in the first message; and encoding the second message in accordance with the second interface.

Aspect 8: The method of any of Aspects 1-7, wherein the first message and the second message are control plane messages.

Aspect 9: The method of any of Aspects 1-8, wherein the inter-RAN node is a first inter-RAN node in a wireless network, and wherein the wireless network includes a second inter-RAN node.

Aspect 10: The method of any of Aspects 1-9, further comprising: discovering a RAN node transport network layer (TNL) identifier (ID) associated with the second RAT RAN node; maintaining a mapping table that includes the RAN node TNL ID and a corresponding RAN node ID; and routing traffic between the first RAT RAN node and the second RAT RAN node based at least in part on the mapping table and routing information provided by one or more of the first RAT RAN node or the second RAT RAN node.

Aspect 11: A method of wireless communication performed by a second radio access technology (RAT) radio access network (RAN) node, comprising: discovering an inter-RAN node associated with a first RAT RAN node; registering the second RAT RAN node with the inter-RAN node; and communicating with the first RAT RAN node via the inter-RAN node.

Aspect 12: The method of Aspect 11, wherein communicating with the first RAT RAN node comprises: transmitting a control plane message to the first RAT RAN node, wherein the control plane message is a non-UE-associated message or a UE-associated message, and wherein the control plane message indicates a source RAN node identifier (ID) associated with the second RAT RAN node and a target RAN node ID associated with the first RAT RAN node.

Aspect 13: The method of any of Aspects 11-12, wherein the first RAT RAN node is a legacy RAN node associated with a first interface, wherein the second RAT RAN node is a non-legacy RAN node associated with a second interface, wherein the first interface is a point-to-point interface, and wherein the second interface is a service-based interface.

Aspect 14: The method of any of Aspects 11-13, further comprising: transmitting, to a user equipment (UE), a measurement configuration to monitor and report measurements associated with one or more first RAT neighbor cells; and receiving, from the UE, a measurement report based at least in part on the measurement configuration, wherein the measurement report includes information associated with the first RAT RAN node, and wherein the inter-RAN node is discovered based at least in part on the first RAT RAN node.

Aspect 15: The method of any of Aspects 11-14, wherein discovering the inter-RAN node comprises: transmitting signaling to a network repository function to identify a node identifier associated with the inter-RAN node.

Aspect 16: The method of any of Aspects 11-15, further comprising: maintaining a neighbor cell relation table that indicates a first RAT cell that is associated with the first RAT RAN node, wherein the neighbor cell relation table is based at least in part on one or more measurement reports for one or more first RAT neighbor cells.

Aspect 17: The method of any of Aspects 11-16, wherein the inter-RAN node is discovered based at least in part on a configuration received from an operations and management entity, wherein the configuration indicates one or more node identifiers (IDs) associated with a range of first RAT RAN node IDs.

Aspect 18: The method of any of Aspects 11-17, wherein the inter-RAN node is discovered based at least in part on one or more user-equipment-reported node identifiers corresponding to one or more first RAT cells.

Aspect 19: The method of any of Aspects 11-18, wherein the inter-RAN node is discovered based at least in part on a first RAT transport network layer identifier discovery via an access and mobility management function.

Aspect 20: The method of any of Aspects 11-19, wherein the inter-RAN node is discovered based at least in part on a network repository function service discovery.

Aspect 21: The method of any of Aspects 11-20, further comprising: obtaining information associated with the inter-RAN node as part of an inter-RAN node registration with the second RAT RAN node.

Aspect 22: The method of any of Aspects 11-21, wherein registering the second RAT RAN node with the inter-RAN node further comprises: transmitting, to the inter-RAN node, a registration request that indicates a global RAN node identifier (ID) associated with the second RAT RAN node; and receiving, from the inter-RAN node and based at least in part on the registration request, a registration response that indicates a global inter-RAN node ID associated with the inter-RAN node.

Aspect 23: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-22.

Aspect 24: An apparatus for wireless communication at a device, the apparatus comprising one or more memories and one or more processors coupled to the one or more memories, the one or more processors configured to cause the device to perform the method of one or more of Aspects 1-22.

Aspect 25: An apparatus for wireless communication, the apparatus comprising at least one means for performing the method of one or more of Aspects 1-22.

Aspect 26: A non-transitory computer-readable medium storing code for wireless communication, the code comprising instructions executable by one or more processors to perform the method of one or more of Aspects 1-22.

Aspect 27: A non-transitory computer-readable medium storing a set of instructions for wireless communication, the set of instructions comprising one or more instructions that, when executed by one or more processors of a device, cause the device to perform the method of one or more of Aspects 1-22.

Aspect 28: A device for wireless communication, the device comprising a processing system that includes one or more processors and one or more memories coupled with the one or more processors, the processing system configured to cause the device to perform the method of one or more of Aspects 1-22.

Aspect 29: An apparatus for wireless communication at a device, the apparatus comprising one or more memories and one or more processors coupled to the one or more memories, the one or more processors individually or collectively configured to cause the device to perform the method of one or more of Aspects 1-22.

Aspect 30: A device comprising a processing system that includes one or more processors and one or more code-storing memories coupled with the one or more processors, the processing system configured to cause the device to perform the method of one or more of Aspects 1-22.

Aspect 31: A device comprising a processing system that includes processor circuitry and code-storing memory circuitry, the processing system configured to cause the device to perform the method of one or more of Aspects 1-22.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a second radio access technology (RAT) radio access network (RAN) node, comprising:
one or more memories; and
one or more processors coupled to the one or more memories, the one or more processors individually or collectively configured to:
discover an inter-RAN node associated with a first RAT RAN node;
register the second RAT RAN node with the inter-RAN node; and
communicate with the first RAT RAN node via the inter-RAN node.

2. The apparatus of claim 1, wherein the one or more processors, to communicate with the first RAT RAN node, are individually or collectively configured to:
transmit a control plane message to the first RAT RAN node, wherein the control plane message is a non-UE-associated message or a UE-associated message, and wherein the control plane message indicates a source RAN node identifier (ID) associated with the second RAT RAN node and a target RAN node ID associated with the first RAT RAN node.

3. The apparatus of claim 1, wherein the first RAT RAN node is a legacy RAN node associated with a first interface, wherein the second RAT RAN node is a non-legacy RAN node associated with a second interface, wherein the first interface is a point-to-point interface, and wherein the second interface is a service-based interface.

4. The apparatus of claim 1, wherein the one or more processors are individually or collectively configured to:
transmit, to a user equipment (UE), a measurement configuration to monitor and report measurements associated with one or more first RAT neighbor cells; and
receive, from the UE, a measurement report based at least in part on the measurement configuration, wherein the measurement report includes information associated with the first RAT RAN node, and wherein the inter-RAN node is discovered based at least in part on the first RAT RAN node.

5. The apparatus of claim 1, wherein the one or more processors, to discover the inter-RAN node, are individually or collectively configured to:
transmit signaling to a network repository function to identify a node identifier associated with the inter-RAN node.

6. The apparatus of claim 1, wherein the one or more processors are individually or collectively configured to:
maintain a neighbor cell relation table that indicates a first RAT cell that is associated with the first RAT RAN node, wherein the neighbor cell relation table is based at least in part on one or more measurement reports for one or more first RAT neighbor cells.

7. The apparatus of claim 1, wherein the inter-RAN node is discovered based at least in part on a configuration received from an operations and management entity, wherein the configuration indicates one or more node identifiers (IDs) associated with a range of first RAT RAN node IDs.

8. The apparatus of claim 1, wherein the inter-RAN node is discovered based at least in part on one or more user-equipment-reported node identifiers corresponding to one or more first RAT cells.

9. The apparatus of claim 1, wherein the inter-RAN node is discovered based at least in part on a first RAT transport network layer identifier discovery via an access and mobility management function.

10. The apparatus of claim 1, wherein the inter-RAN node is discovered based at least in part on a network repository function service discovery.

11. The apparatus of claim 1, wherein the one or more processors are individually or collectively configured to:
obtain information associated with the inter-RAN node as part of an inter-RAN node registration with the second RAT RAN node.

12. The apparatus of claim 1, wherein the one or more processors, to register the second RAT RAN node with the inter-RAN node, are individually or collectively configured to:
transmit, to the inter-RAN node, a registration request that indicates a global RAN node identifier (ID) associated with the second RAT RAN node; and
receive, from the inter-RAN node and based at least in part on the registration request, a registration response that indicates a global inter-RAN node ID associated with the inter-RAN node.

13. A method of wireless communication performed by a second radio access technology (RAT) radio access network (RAN) node, comprising:
discovering an inter-RAN node associated with a first RAT RAN node;
registering the second RAT RAN node with the inter-RAN node; and
communicating with the first RAT RAN node via the inter-RAN node.

14. The method of claim 13, wherein the first RAT RAN node is a legacy RAN node associated with a first interface, wherein the second RAT RAN node is a non-legacy RAN node associated with a second interface, wherein the first interface is a point-to-point interface, and wherein the second interface is a service-based interface.

15. The method of claim 13, further comprising:
transmitting, to a user equipment (UE), a measurement configuration to monitor and report measurements associated with one or more first RAT neighbor cells; and
receiving, from the UE, a measurement report based at least in part on the measurement configuration, wherein the measurement report includes information associated with the first RAT RAN node, and wherein the inter-RAN node is discovered based at least in part on the first RAT RAN node.

16. The method of claim 13, wherein discovering the inter-RAN node comprises:
transmitting signaling to a network repository function to identify a node identifier associated with the inter-RAN node.

17. The method of claim 13, further comprising:
maintaining a neighbor cell relation table that indicates a first RAT cell that is associated with the first RAT RAN node, wherein the neighbor cell relation table is based at least in part on one or more measurement reports for one or more first RAT neighbor cells.

18. The method of claim 13, wherein:
the inter-RAN node is discovered based at least in part on a configuration received from an operations and management entity, wherein the configuration indicates one or more node identifiers (IDs) associated with a range of first RAT RAN node IDs;
the inter-RAN node is discovered based at least in part on one or more user-equipment-reported node identifiers corresponding to one or more first RAT cells;
the inter-RAN node is discovered based at least in part on a first RAT transport network layer identifier discovery via an access and mobility management function; or
the inter-RAN node is discovered based at least in part on a network repository function service discovery.

19. The method of claim 13, wherein registering the second RAT RAN node with the inter-RAN node further comprises:
transmitting, to the inter-RAN node, a registration request that indicates a global RAN node identifier (ID) associated with the second RAT RAN node; and
receiving, from the inter-RAN node and based at least in part on the registration request, a registration response that indicates a global inter-RAN node ID associated with the inter-RAN node.

20. A non-transitory computer-readable medium storing a set of instructions for wireless communication, the set of instructions comprising:
one or more instructions that, when executed by one or more processors of a second radio access technology (RAT) radio access network (RAN) node, cause the second RAT RAN node to:
discover an inter-RAN node associated with a first RAT RAN node;
register the second RAT RAN node with the inter-RAN node; and
communicate with the first RAT RAN node via the inter-RAN node.
